(19) United States
(12) Patent Application Publication
(10) Pub. No.: US 2006/0222171 A1
(43) Pub. Date: Oct. 5, 2006

(54) Service-specific treatment of a call request in terms of the called subscriber line

(75) Inventors: Fritz-Heinrich Dieckhoner, Munchen (DE); Jurgen Lantermann, Munchen (DE); Eduard Wijns, Duffel (BE)

Correspondence Address: MORRISON & FOERSTER LLP, 1650 TYSONS BOULEVARD, SUITE 300, MCLEAN, VA, 22102, US

(73) Assignee: Siemens AG, Munich (DE)

(21) Appl. No.: 11/446,221

(22) Filed: Jun. 5, 2006

Related U.S. Application Data
(63) Continuation of application No. 10/471,455, filed on Apr. 26, 2004, now abandoned.

(30) Foreign Application Priority Data
Mar. 13, 2001 (EP) 01106138.9

(51) Int. Cl. H04M 9/00

(52) U.S. Cl. 379/394

(57) ABSTRACT

For the recognition of a teleservice when establishing a call in a telephone network from a calling party to a target subscriber, on the basis of the call request, in an exchange of the network, preferably a target exchange assigned to the target subscriber, a signal identifier is temporarily applied to the requested call, for a duration that is at least sufficient for the calling party to send out a service call signal that indicates a teleservice. If a service call signal was received by the signal identification, this signal is evaluated with regard to the indicated service, and further handling of the call is carried out as a function of the service indicated in this manner.

### CLAIM FOR PRIORITY

This application is a continuation application of U.S. Ser. No. 10/471,455, filed Apr. 26, 2004, which claims priority to International Application No. PCT/EP/02587, which was published in the German language on Sep. 19, 2002, which claims the benefit of priority to German Application No. 01106138.9, which was filed in the German language on Mar. 13, 2001, this disclosures of which is incorporated herein.

### TECHNICAL FIELD OF THE INVENTION

The invention relates to a method for handling a call request for a target subscriber on a telephone network in which a request for a call to the target subscriber is made by a calling party, to the network. In this, a call can also be requested for the use of a teleservice.

### BACKGROUND OF THE INVENTION

In addition to the actual telephone service, various communications services can also take place on telephone networks that are implemented as so-called teleservices on the basis of transmission services made available by the telephone service (OSI layers up to 3 and higher OSI layers). Teleservices are, for example, fax service or data transmission by modem.

Often, a terminal for only one specific teleservice—a fax machine, for example—is connected to a subscriber line, or only a phone is connected, which is not designed for any of the teleservices but only for usual person-related telephone traffic. It is therefore desirable that incoming call requests for a specific teleservice not be put through to a line that cannot utilize this service. For example, the case can occur that a fax is to be sent by an automatic fax machine, but by mistake a wrong telephone number is programmed in that is assigned to a telephone subscriber; this subscriber would be bothered by an attempt to make a call that he or she cannot take (the fax tone is perceived as very unpleasant, in most cases), possibly even by a series of call attempts. In specific cases, this can go so far that the called telephone subscriber blocks his or her phone in order to avoid the annoyance and now cannot be reached for other calls, either.

The case can also arise that a number of terminals is assigned to a telephone number, each of which can be used for specific services, for example a phone, a fax machine, and a modem for data transmission (for example for e-mail messages). An incoming call should then be sent to the appropriate terminal or connection, depending on the desired service.

Therefore, the desire exists to be able to evaluate information about the request of the calling party (A side) relating to a service, with regard to the switching traffic directed at the terminating party—i.e., the target subscriber (B side). For example, the terminal selection on the B side can be controlled in this way, for example for service-specific “line hunting,” or a selective ring control can take place, so that a specific ring is given off by the B-side terminal, depending on the service being requested.

This presupposes that the A-side service request can be made known to the B-side target exchange. This can be achieved, for example, in that the standardized service identifiers that are transmitted along with the intermediate exchange signal are evaluated and taken into consideration, for example the identifiers defined according to ITU-T recommendation Q.939 (see Sections 3 and 6.3). If the A side is an ISDN terminal, the transmitted standardized service identifiers already contain sufficient information. However, in the case of an analog A side, or any analog terminal on an ISDN Ta/b adapter, the transmitted services information is not sufficient for this purpose. Thus, for example, the identifier “Audio 3.1 kHz” is used for group 3 fax or modem transmissions according to ITU/ETSI, which is the same identifier as for analog voice calls. Therefore no reliable differentiation between voice, fax, and data calls is possible on the basis of the service identifier in the signal.

According to the known method, the detection of the teleservice that is being transmitted from the analog A side then takes place for an analog terminal only after the call has been put through to the terminal. This will be illustrated briefly with two examples, namely, a fax transmission and a modem transmission. The known solution for fax transmissions is based on the ITU-T recommendation T.30 (July 1996 edition), “Procedures for document facsimile transmission in the general switched telephone network.” Since only the services differentiation, ahead of the useful data transmission, is of concern within the framework of the invention described here, Phase A (“call establishment”) is the deciding factor here (see Sections 1 to 4 of T.30). Of the operating methods defined for Phase A, mainly those methods will be considered in the following that contain automatic operation on the A side, i.e. the operating methods 3 (A-side automatic, B-side manual operation; Point 3.1.3 of T.30), and 4 or 4b (A-side and B-side automatic operation; Points 3.1.4 and 3.1.5 of T.30). The active identification as a fax terminal (Group 3) takes place, according to T.30, by means of sending a so-called CNG tone (CNG for “calling tone”), which is defined as a 1.1 kHz tone having a duration of 0.5 s, which is periodically repeated at intervals of a pause of 3 s (see Section 4.2 of T.30).

For data modems, the known solution is based on the ITU-T recommendation V.25 (October 1996 edition), “Automatic answering equipment and general procedures for automatic calling equipment on the general switched telephone network.” For establishing up the call, Event 3.7 of the interface procedures at the call-generating data location (Section 3 of V.25) is particularly decisive. The active identification as a modem takes place, according to V.25, by means of sending a so-called CT signal (“calling tone”), which is defined as a 1.3 kHz tone having a duration of 0.5 to 0.7 s, which is periodically repeated at intervals of a pause of 1.5 to 2 s (see Section 3, particularly FIG. 1, of V.25).

The CNG signal is obligatory on the A side for fax machines according to T.30 (1996 edition); fax machines that are not in conformity with this standard have not been on the market for a long time, and hardly any of them are in use any more. The same holds true for modems with regard to the CT signal based on V.25 (1996 edition).

According to the ITU-T standards, the calling A terminal indicates what teleservice is being requested by means of the CNG or CT signal immediately after the dialed numbers are sent in order to establish the call to the B terminal.

### SUMMARY OF THE INVENTION

The invention discloses services-specific handling can be carried out on the B side, in an exchange-integrated manner, without having to expand the usual signaling for this purpose and independent of the type of the A side (for example, analog or ISDN).

This task is accomplished by a method of the type stated initially, wherein, according to the invention, on the exchange side of the network,
a) a signal identifier is temporarily applied to the requested call in the exchange, for a duration that is at least sufficient for the calling party to send out a services call signal that indicates the teleservice, and
b) in the event that a services call signal has been received by the signal identification, this signal is evaluated with regard to the indicated service, and further handling of the call is carried out as a function of the service indicated in this manner.

This solution permits sufficiently reliable recognition of an analog fax or modem transmission, over and above the known service identifier and, beyond this, the derivation from this of control criteria for services-specific handling on the part of the network. By means of the delay according to the invention of the beginning of the signaling process during call establishment with the exchange, it is possible to generate differentiation characteristics from the signaled or otherwise transmitted identifiers that permit differentiation of the teleservices, particularly voice, fax, or data services. In this, the method according to the invention does without an expansion of the intermediate exchange signaling, which would be connected with incompatibilities.

According to the invention, in the event that no service call signal has been received from the signal recognition, in that instead of step b) the call is put through as a telephone call to a telephone line of the target subscriber. This handling in the event that no service call identifier is given is practical if a voice telephone line is indicated at the called telephone number, for example, with the call then being put through to this line. A possible alternative further handling would be rejection of the call, for example, if only teleservices equipment is connected to the related telephone number.

It is advantageous if the recognition and evaluation of the service call signal can be carried out on the part of the target exchange of the network assigned to the target subscriber. In this case, the entire service-dependent call handling takes place in the target exchange, i.e. the terminating exchange from which the related subscriber line is handled—while the network-internal signal traffic remains unchanged.

In this context, it can be desirable that handling incoming call requests according to the invention takes place only if this had been previously requested by the target subscriber in question. In such a case, it is advantageous if the system checks, on the basis of subscriber data provided on the part of the target exchange, whether the recognition/evaluation of service call signals, or service-dependent call handling, is activated for the target subscriber, and if the method starting from step a) is carried out only if this is activated, otherwise the call is put through to a telephone line of the target subscriber as a telephone call.

In order to achieve early recognition of a teleservice, it is advantageous if after recognition and evaluation of the service call signal on the part of the exchange (which is different from the target exchange in this case), service information that designates the service indicated according to the evaluation is passed on to a target exchange in the network that is assigned to the subscriber, together with the call request. In this context, there can advantageously be a provision that the target exchange checks, on the basis of the service information as well as using subscriber data provided by the target exchange, whether the recognition/evaluation of service call signals, i.e. service-dependent call handling, is activated for the target subscriber and, only in the event that this is activated, further handling of the call is carried out, e.g. rejection of the call or putting it through to a network line, as a function of these data, including the service information, otherwise the call is put through to a telephone line of the target subscriber as a telephone call.

### BRIEF DESCRIPTION OF THE DRAWINGS

The invention is described in detail below with reference to the drawings, in which:

FIG. 1 shows a flow chart of the procedures at the beginning of the fax transmission according to the invention.

### DETAILED DESCRIPTION OF THE INVENTION

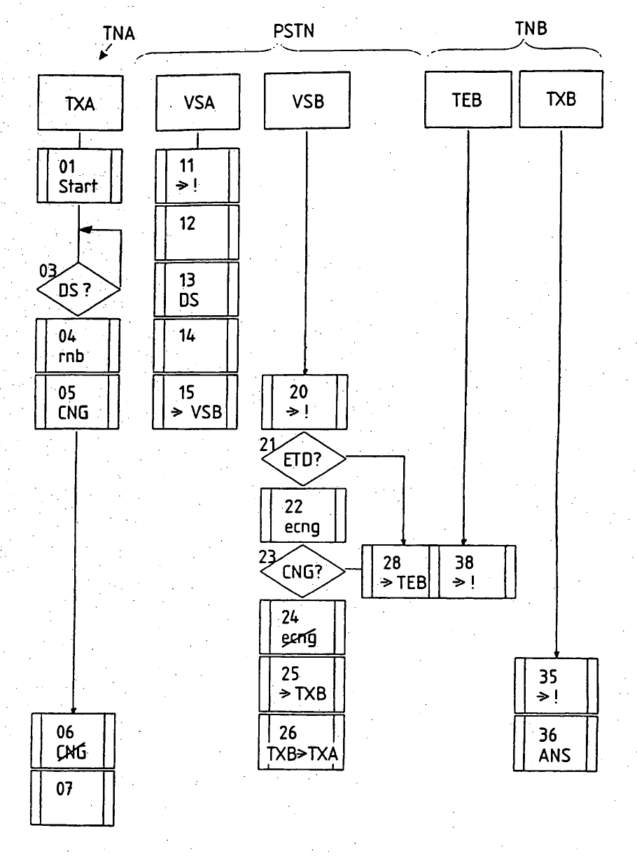

In FIG. 1, the network locations involved in the procedures discussed below are arranged next to one another. These are, in detail, an analog fax machine TXA of a (calling) subscriber TNA; the fax machine TXA is connected with a telephone network PSTN by way of a first exchange VSA. A fax message is supposed to be transmitted from the fax machine TXA, specifically to a subscriber TNB, who has not only a phone TEB for voice telephony but also a fax machine TXB. Both devices TEB, TXB are connected with the telephone network PSTN by way of an exchange VSB; in the exemplary embodiment being considered, this exchange VSB therefore represents the target exchange in the sense of the invention. The calling and connection means of the network PSTN, including those between the exchanges VSA, VSB as well as to the terminals TXA, TEB, TXB, can be implemented in a known manner and are not of further concern for the invention.

The individual method steps of the sequence shown in the figure are identified with reference symbols in the form of two-digit numbers. In this context, those steps that are essentially simultaneous are arranged next to one another; consecutive steps are arranged from top to bottom, among one another, unless a different time sequence is indicated by arrow lines.

The first steps that take place between the fax machine TXA and the exchange VSA are known. After the start of the fax machine TXA—Step 01—the latter emits an “off-hook” signal. The exchange VSA recognizes the off-hook signal in Step 11, starts the number recording for a telephone number to be expected from the terminal TXA in Step 12, and applies a dial tone DS in Step 13. After the device TXA has recognized the dial tone—Step 03—it transmits the telephone number rnb of the target subscriber TNB to the exchange VSA in Steps 04 and 14. Subsequently in Step 05, in other words even before the call is switched through to the end subscriber, the fax machine TXA applies the CNG tone pursuant to the ITU-T standards. In the next step 15, 20, the exchange VSA routes to the exchange VSB, which is assigned to the target subscriber telephone number rnb.

The exchange VSB is set up for services-specific handling of the traffic that terminates at the subscriber TNB, according to the prerequisites according to the invention, as in the example. For this purpose, tone receivers of a known type are provided on the part of the exchange VSB, which can be switched into or looped into a telephone call that is being established as needed. In the embodiment being considered here, the tone receivers are set up to detect service call signals, in this case the CNG signal for a fax transmission in a known manner and to report to the control of the exchange that they have been received.

Advantageously, a provision can be made that an attribute ETD assigned to the subscriber TNB—i.e., to the related lines, which can be an analog individual or collective line, an ISDN base line, or an ISDN primary line, for example—is administered that relates to recognition of the teleservices. This can be implemented in a services-specific manner, for example, such as the characteristic “fax group 3 recognition” (or “modem recognition”). The attribute is stored in memory in the semi-permanent subscriber database of the exchange VSB, and can be assigned both in line-related manner (with reference to the related line port) and in telephone-number-related manner.

It is practical if such an attribute is activated if the operator of the network PSTN or the exchange VSB has been informed by the subscriber TNB in question that the latter wishes to use a service-specific selection, for example according to the type of the example being discussed here. For example, the subscriber can activate the attribute by way of an access code, whereby the type of services-specific handling can be selected by means of subsequently dialed numbers, for example putting fax calls through to a different line TXB, putting them through to the same line with a different call signal, rejection of fax calls, etc. If desired, the access code can additionally be protected with a password. The services-specific handling can be de-activated again by way of a second access code, for example, so that no differentiation in the teleservices is made in the exchange, and all calls are put through to the telephone line TNB, for example.

On the part of the exchange VSB when a call request is received 20 according to the invention—Step 21—the system checks whether an attribute ETD relating to the recognition of teleservices according to the invention has been set for the related line or network gateway before any call establishment to a B-side terminal is performed by the exchange.

If the attribute ETD has been set, the recognition of a service call signal—Step 22—is started, in this case the recognition ecng of a CNG signal. For this purpose, a tone receiver is looped into the communications connection that is being established, for example before the call is switched through to the B-side terminal, i.e., before the gateway, until it has been recognized with sufficient certainty whether the A side has sent a CNG signal (or a different service call signal in accordance with the settings).

It is evaluated as being sufficiently secure for the reception of a CNG signal (or CT signal) if a 1.1 kHz signal with a frequency deviation of maximally ±38 Hz and a duration of 425 to 575 ms (or, respectively, a 1.3 kHz signal with a maximum frequency deviation of ±15 Hz and a duration of 600 ms ±100 ms) has been recognized, the start of which lay within a detection window of 3450 ms. This results in a total recognition period of approximately 4025 ms (or 4150 ms, respectively).

After the recognition period has elapsed, the system checks—Step 23—whether a service call signal has been received. If the CNG signal has been recognized, then the tone recipient is looped out—Step 24—and an exchange-technology identifier is set in the exchange VSB, which is taken into consideration in the further services-specific handling. The call is passed to the B-side line or gateway with the services identifier “fax group ⅔” (or “modem,” respectively) in Step 25, 35; the related terminal answers with an “answer” signal—ANS signal—Step 36—for example, and the call is switched through in Step 26.

For those lines for which the attribute for recognition of a service call signal has been activated, the call establishment is delayed by up to 4.025 s for calls with the services identifier “Audio 3.1 kHz” because the service call recognition has been turned on in the terminating exchange VSB. Laboratory studies of the applicant have shown, however, that the delay in the call establishment is typically about 1.5 s. If the attribute is not set, there is no delay.

The remainder of the call establishment takes place according to the IT-U standard T.30. The A side continues to send CNG signals until the B side has changed over to Phase B (“pre-message procedure”) of the call establishment process. The other CNG signals can be used, for example, in order to trigger other control functions in the B-side terminal, or, if applicable, in an end user device that is located ahead of it, for example a fax switch. The transition to Phase B is completed in accordance with T.30 by means of sending a so-called DIS signal (“digital identification signal”), with which the B side makes its terminal properties known, whereupon the A side stops sending the service call signal—Step 06. The remainder of the call establishment procedure 07 and the fax transmission, in particular of the content data, take place as specified in T.30.

The call establishment proceeds in analogous manner in the case of a modem transmission, whereby in this case, V.25 is referred to. Analogous to the method of procedure described above with regard to a fax, the A side continues to send CT signals until they are acknowledged by the B side by sending a so-called ANS signal. The CT signals can also be used to trigger additional control functions on the B side. If, on the other hand, the detection window, i.e., if the recognition period has elapsed without a service call signal, the call is considered to be a voice telephone call and is then handled as such. In the example being considered here, this means that the tone receiver is looped out and the call is put through to the telephone TEB—Steps 28, 38.

In addition to the methods of procedure for automatic operation on the A side as described above, manual operation on the A side (corresponds to operating method 1 or 2 for fax) can also be supported, with adherence to suitable provisions. For this purpose, it must be presupposed that the A side does not wait for a verbal exchange with the B side in operating method 1 (both sides manual), or, in the case of operating method 2 (only B side is automatic), the A side does not wait for a so-called CED signal sent by the B side (“called terminal identification answer tone”) according to T.30; instead, the operator on the A side is supposed to switch over to fax manually even before the B side answers, e.g. by means of an “answer” signal. In this case, the A-side terminal, in the case being considered here, the fax machine TXA, sends the CNG signal (or a corresponding service call signal) immediately, and for the remainder acts like an automatic device.

The solution according to the invention takes advantage of the fact that according to the ITU-T procedures, the A side and the B side are uncoupled in their sequences while the call is being established, at first; in particular, the service call signal—particularly the CNG or CT signal—can already be sent by the A side before the B side has acknowledged that the call has been established, for example with an “answer” signal.

On the basis of the invention, the terminal selection can be controlled on the B side, for example for services-specific “line hunting,” or selective ring control. Furthermore, other terminal-side handling methods can also be provided. An example of this is service-specific call rejection; in this context, a provision can be made that a triggering message is sent to the A side by the target exchange that indicates to the A side that the desired B side cannot (or does not want to) operate the requested service.

The services-specific handling of the call request can also take place in a different exchange, in a generalization of the example presented above, for example on the part of the calling subscriber, i.e., the exchange VSA assigned to him or her, as well as a network gateway or in a central network node. The possibilities of fax/modem recognition as described above for the target exchange are possible in digital networks that can signal service identifiers in known manner, both at the A side and also at a network gateway, or, using routing options for example, in central network nodes of the telephone network PSTN. In this context, the service recognition takes place as described above, whereby once again, signal recognition can be turned on for every call or only for lines marked for this purpose. After a service call signal has been recognized, a corresponding services identifier is generated, and this is passed on to the target location as a signal during the remainder of the call establishment. In this manner, the standards for digital networks mentioned initially permit a service-dependent differentiation.

Services-specific handling of the B-side switching is made possible by means of the invention, for all analog and ISDN services in an exchange network, particularly also for the services of voice, fax, and modem that are brought together in analog networks, and, in particular, in the interaction between analog and ISDN lines, as well as network gateways to data networks. The invention thereby closes a gap in standardization, but without providing for incompatible expansions. Therefore the invention can also be introduced into existing networks as a subsequent part.

1. A method for influencing a call establishment in a services-specific manner, wherein a calling party places a call request to a target subscriber using a telephone network, on a part of an exchange of the network, before the call establishment is processed further, the method comprising:
temporarily applying a signal identifier to the requested call in the exchange for a duration that is at least sufficient for the calling party to send out a service call signal that indicates a teleservice; and
if a service call signal was received by the signal identification, evaluating the signal with regard to the indicated service, and performing further handling of the call establishment as a function of the service indicated.

2. The method according to claim 1, wherein if no service call signal was received by the signal recognition, the evaluating of the signal is replaced by putting the call through as a telephone call to a telephone line of the target subscriber.

3. The method according to claim 1, wherein the recognition and evaluation of the service call signal are performed on the part of the target exchange of the network that is assigned to the target subscriber.

4. The method according to claim 3, wherein, based on the call request, the system checks, based on subscriber data provided on the part of the target exchange, whether the recognition/evaluation of service call signals, or service-dependent call handling, is activated for the target subscriber, and the method is performed if activated, otherwise the call is put through to a telephone line of the target subscriber as a telephone call.
